(19) United States
(12) Patent Application Publication
(10) Pub. No.: US 2015/0334184 A1
(43) Pub. Date: Nov. 19, 2015

(54) ENABLING EXECUTION OF REMOTELY-HOSTED APPLICATIONS USING APPLICATION METADATA AND CLIENT UPDATES

(71) Applicant: HEW-LETT-PACK DEVELOPMENT COMPANY, L.P., Houston, TX (US)

(72) Inventor: Fletcher Liverance, (US)

(21) Appl. No.: 14/367,765

(22) PCT Filed: Dec. 22, 2011
(86) PCT No.: PCT/US2011/066738

§ 371 Date: Jun. 20, 2014

(51) Int. Cl. H04L 29/08; H04L 29/06

(52) U.S. Cl. CPC H04L 67/1097; H04L 67/42; H04L 67/32

(57) ABSTRACT

Example embodiments relate to enabling execution of remotely-hosted applications via transmission of application metadata and client updates from a cloud server to a client device. In example embodiments, a cloud server maintains application metadata describing a remotely-hosted application. To enable remote execution of the applications by a client device, the cloud server sends the client device the application metadata and a corresponding client update that enables execution of the remotely-hosted application by the client device.

### BACKGROUND

In some scenarios, a user may desire to locally execute a software application using a client computing device, but may be unable to do so for a number of reasons. For example, the device may be unable to optimally execute a resource-intensive application if the device lacks hardware with sufficient processing capabilities. As another example, the application may not be locally installed and the user may lack administrative rights to install the application. In each of these scenarios, the client device may instead use a remoting protocol to access a remote server that locally executes the application. Although the application runs on the server, the user may interact with the remotely-hosted application as if it were running locally on the client.

### BRIEF DESCRIPTION OF THE DRAWINGS

The following detailed description references the drawings, wherein:

FIG. 1 is a block diagram of an example cloud server computing device for enabling execution of remotely-hosted applications by providing application metadata and corresponding client updates to a client device;

FIG. 2 is a block diagram of an example client computing device for enabling execution of remotely-hosted applications by receiving application metadata and corresponding client updates from a cloud server;

FIG. 3 is a block diagram of an example server computing device in communication with a client computing device, an administrator computing device, a remote update server, and remote application hosts for enabling remote execution of applications by the client computing device;

FIG. 4A is a flowchart of an example method for execution by a cloud server computing device for receiving application metadata from an administrative user and forwarding the metadata and a corresponding client update to a client device;

FIG. 4B is a flowchart of an example method for execution by a client computing device for receiving application metadata and a corresponding client update from a cloud server, and utilizing the metadata and update to execute a remotely-hosted application;

FIG. 5A is a flowchart of an example method for execution by a cloud server computing device for receiving application metadata from an administrative user, authenticating a client device, and forwarding the metadata and a corresponding client update to the authenticated client device; and

FIG. 5B is a flowchart of an example method for execution by a client computing device for providing authentication information to a cloud server, receiving application metadata and a corresponding client update from the cloud server, and utilizing the metadata and update to execute a remotely-hosted application.

### DETAILED DESCRIPTION

As detailed above, remoting protocols enable a client device to locally access an application that is hosted on a remote server. For example, suppose the user desires to execute a 3D computer-aided design (CAD) application, but the client device lacks hardware with sufficient processing capabilities to locally execute the CAD application. To address this problem, the user may use a network to connect the client device to a remote host that is executing the CAD application. The client device may then receive and display graphical information from the remote host, while transmitting keyboard, mouse, and/or touch input to the server. In this manner, the user may harness the resources of the remote host, while still interacting with the application as if it were executing on the client device itself.

Various server architectures may be utilized to facilitate remote execution of applications by client devices in a network. For example, a server known as a Virtual Desktop Infrastructure (VDI) broker may store information regarding remote hosts and applications available on those hosts. Based on requests from client devices in the network, the VDI broker may then provide connection information to the clients, such that the client devices may connect to the remote hosts to access the remotely-hosted applications.

In current VDI infrastructures, the VDI broker typically maintains application information in a manner that is agnostic to the client requirements for each remotely-hosted application. Thus, the broker is generally unaware of decoders, drivers, management tools, and other software required by a client device to enable remote execution of each application. As a result, even though the client may receive the requisite connection information from the broker, the client may still lack the appropriate software to successfully execute the remotely-hosted applications.

Example embodiments disclosed herein address these issues by providing a remote application hosting infrastructure that utilizes a cloud server to manage distribution of both remote application metadata and client updates for supporting execution of the remote applications. For example, in some embodiments, a cloud server maintains application metadata describing a remotely-hosted application. To enable remote execution of the applications by a client device, the cloud server sends the client device the application metadata and a corresponding client update that enables execution of the remotely-hosted application by the client device. The client may then install the client updates, connect to the remote host specified in the metadata, and execute a particular remotely-hosted application, while using the installed client update to support execution of the application.

In this manner, example embodiments disclosed herein provide a remote application hosting framework that significantly simplifies the configuration of client devices. In particular, by managing client updates using a cloud server, example embodiments minimize manual identification and installation of client updates used to support execution a remotely-hosted applications by a client. Furthermore, because the cloud server is accessible from any Internet-connected location, each client may receive the appropriate metadata and client updates regardless of its location. As a result, the client device may simply connect to a single cloud server from any location, receive application metadata and appropriate updates, and configure itself to allow the user to access the remotely-hosted applications.

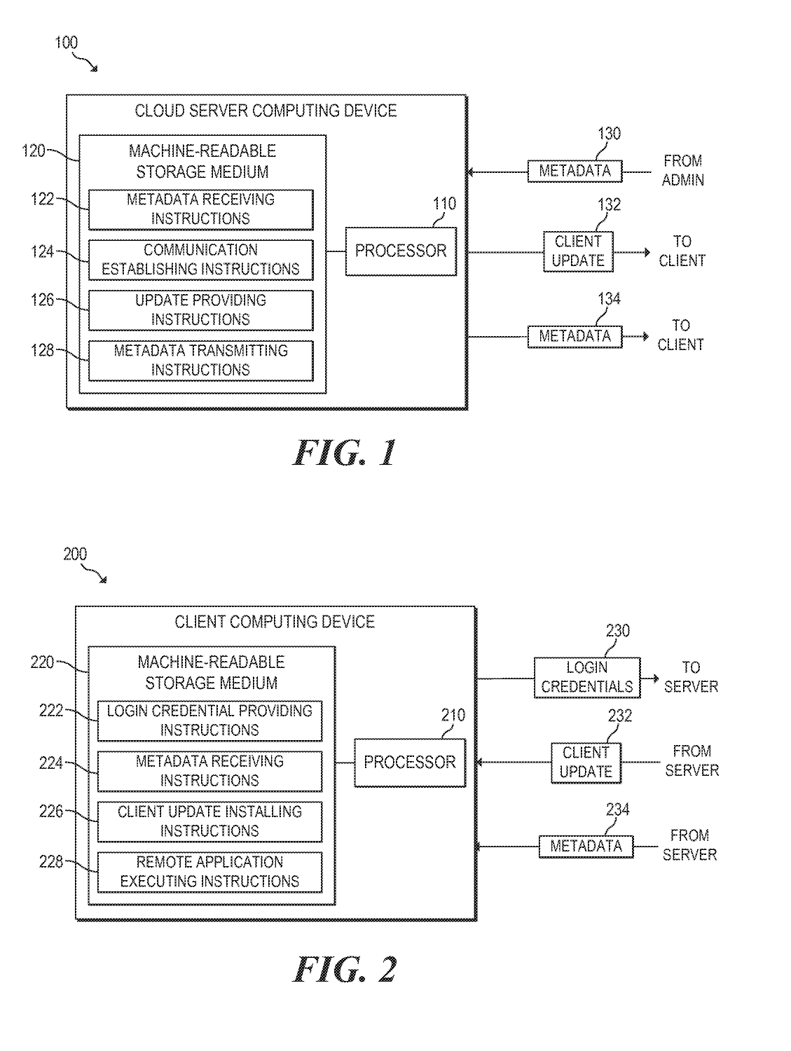

Referring now to the drawings, FIG. 1 is a block diagram of an example cloud server computing device 100 for enabling execution of remotely-hosted applications by providing application metadata 134 and corresponding client updates 132 to a client device. Cloud server computing device 100 may be any computing device accessible to a client device, such as client computing device 200 of FIG. 2, over the Internet. In the embodiment of FIG. 1, cloud server computing device 100 includes a processor 110 and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to enable client execution of remotely-hosted applications, as described below. As an alternative or in addition to retrieving and executing instructions, processor 110 may include one or more electronic circuits comprising a number of electronic components for performing the functionality of one or more of instructions 122, 124, 126, 128.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for enabling client execution of remotely-hosted applications.

Metadata receiving instructions 122 may initially receive application metadata 130 from an administrative user. For example, the administrative user may connect to cloud server computing device 100 using a network-based interface, such as a web-based application. The administrative user may then provide metadata 130 to server 100 to thereby identify available remote host devices and the applications supported by those host devices. Upon receipt of the metadata 130 from an administrative user, metadata receiving instructions 122 may then store the received metadata 130 in a storage device accessible to server computing device 100.

The received application metadata 130 may include, for each application, an identification of the remotely-hosted application and a location of a corresponding host device that hosts the application. The identification of the remotely-hosted application may include, for example, the name of the particular application and a description of the application (e.g., a category, summary of the functionality, etc.). Additionally, the location information included in metadata 130 may be any information sufficient to allow a client device to subsequently connect to the host device. As one example, the location information may include an Internet Protocol (IP) address and a port of the host device. In some implementations, the location information may further include configuration information, such as an identification of a communication protocol to be used by the client in communicating with the host device (e.g., Citrix Independent Computing Architecture (ICA), Microsoft Remote Desktop Protocol (RDP), etc.) and settings for the identified protocol.

Communication establishing instructions 124 may then establish communication with a client device via an Internet connection. For example, a particular client device may access server 100 at a predetermined Uniform Resource Locator (URL) and, in response, server 100 may establish a communication session with the client. In some implementations, establishing instructions 124 may also receive client login credentials, such as a user identifier and a corresponding authentication parameter (e.g., a password).

After establishing a connection with the client, update providing instructions 126 may provide a client update 132 to the client device to enable execution of remotely-hosted applications by the client. For example, after establishing communication with the client, server 100 may first identify the remotely-hosted applications to be made available to the client. Server 100 may maintain application permission information identifying the users permitted to access each available application, as specified by the administrative user. After receiving a client identifier (e.g., user identifier, IP address, etc.) from a client device, server 100 may then identify the applications to be made available to the client device by accessing the stored application permission information.

Next, for each remotely-hosted application to be made available to the client, update providing instructions 126 may transmit any available client updates 132 to the client device. In response, the client device may install each update received from server 100 to enable remote execution of the remotely-hosted application by the client device.

Each client update 132 may be any set of instructions that provides the client device with the functionality required for or otherwise used to support execution of a remotely-hosted application. For example, the client update 132 may be a decoder for use by the client device in decoding a stream of data to be provided by the host device during execution of the application. The client update 132 may also be an application for use by the client in connecting to the remote host, such as a virtual private network (VPN) client. As another example, the client update 132 may be a hardware driver for improving performance of the client device when executing the remotely-hosted application, such as a video interface driver or an audio interface driver. Still further, the client update 132 may be a management tool update for enabling the administrative user to remotely connect to the client device. Finally, as a last example, the client update 132 may be a local redirector for enabling redirection of resources from the client device to the host device (e.g., Universal Serial Bus (USB) redirection, printer redirection, etc.).

The source of the client update 132 may vary by embodiment. In some implementations, cloud server 100 may receive the client update 132 from the administrative user and store the received client update 132 on an accessible storage device. For example, when providing metadata 130 to cloud server 100 for a particular remotely-hosted application, the administrative user may also upload any client updates used to support execution of the particular application. In other implementations, cloud server 100 may retrieve the client update 132 from a remote server subsequent to receiving the metadata 130 from the administrative user. For example, cloud server 100 may provide the application identifier included in metadata 130 to a remote server and, in response, receive any applicable client updates 132 for the corresponding application.

In addition to providing the client update 132 to the client, cloud server computing device 100 may also transmit the application metadata 134 to the client device. More specifically, metadata transmitting instructions 128 may transmit metadata 134 for each remotely-hosted application to the client device. As with metadata 130, the transmitted metadata 134 may identify a particular remotely-hosted application, a location of a host device that hosts the application, and any additional information for use by the client in accessing the host device. Thus, in combination with client update 132, metadata 134 may be sufficient for the client to subsequently connect to the host device and begin remote execution of the remotely-hosted application.

FIG. 2 is a block diagram of an example client computing device 200 for enabling execution of remotely-hosted applications by receiving application metadata 234 and corresponding client updates 232 from a cloud server. Client computing device 200 may be, for example, a notebook computer, a desktop computer, an all-in-one system, a thin client, a workstation, a tablet computing device, a mobile phone, or any other computing device suitable for execution of the functionality described below. In the embodiment of FIG. 2, client computing device 200 includes processor 210 and machine-readable storage medium 220.

As with processor 110 of FIG. 1, processor 210 may be one or more CPUs, microprocessors, and/or other hardware devices suitable for retrieval and execution of instructions. Processor 210 may fetch, decode, and execute instructions 222, 224, 226, 228 to implement the remotely-hosted application execution procedure described below. Processor 210 may also or instead include electronic circuitry for performing the functionality of one or more instructions 222, 224, 226, 228. As with storage medium 120 of FIG. 1, machine-readable storage medium 220 may be any physical storage device that stores executable instructions.

Login credential providing instructions 222 may initially provide login credentials 230 to an Internet-accessible server at a predetermined location. For example, client computing device 200 may connect to a cloud server, such as cloud server 100 of FIG. 1. The predetermined location of the server may be a Uniform Resource Locator (URL) accessible to client computing device 200 via the Internet and, in some cases, the URL may be preinstalled in an operating system of client 200. In some implementations, the operating system may automatically connect to the predetermined URL upon initialization of the operating system, thereby facilitating automatic configuration of client computing device 200 without the need for the user to know the predetermined URL.

Regardless of its location, server 100 may initially provide a login interface to client 200. Client 200 may then output the login interface on an available display, receive input of the login credentials 230, and forward the login credentials 230 to the cloud server. For example, the user may enter a user identifier, such as a user name, and a corresponding authentication parameter, such as a password, and client 200 may then forward the entered data to the cloud server.

Upon successful authentication of the user to the server, metadata receiving instructions 224 may then receive application metadata 234 corresponding to the provided login credentials 230. As detailed above, metadata 234 may identify a remotely-hosted application and a location of a corresponding host device. In some implementations, the server may provide metadata 234 that is specific to the entered login credentials 230, such that the server provides customized metadata for each user.

Prior to, concurrently with, or subsequent to receipt of metadata 234, client update installing instructions 226 may receive a client update 232 that enables remote execution of the remotely-hosted application. Client update 232 may be any set of instructions for supporting execution of the application, such as a decoder, VPN client, driver, management tool, and the like. Installing instructions 226 may then install the client update 232 on client 200, such that client 200 may then successfully execute the remotely-hosted application. For example, client 200 may copy the client update 232 to a predetermined storage location or execute the update 232 when the update is an executable file.

Finally, remote application executing instructions 228 may execute the remotely-hosted application by connecting to the remote host specified in metadata 232, while utilizing the installed client update 232 to enable execution of the application. For example, executing instructions 228 may initialize a remoting protocol for connecting to the remote host (e.g., ICA, RDP, etc.), establish a connection with the remote host, and begin receiving remote graphics data from the host, while providing input data to the host. In this manner, the user of client 200 may interact with the remotely-hosted application as if the application were executing locally on client 200.

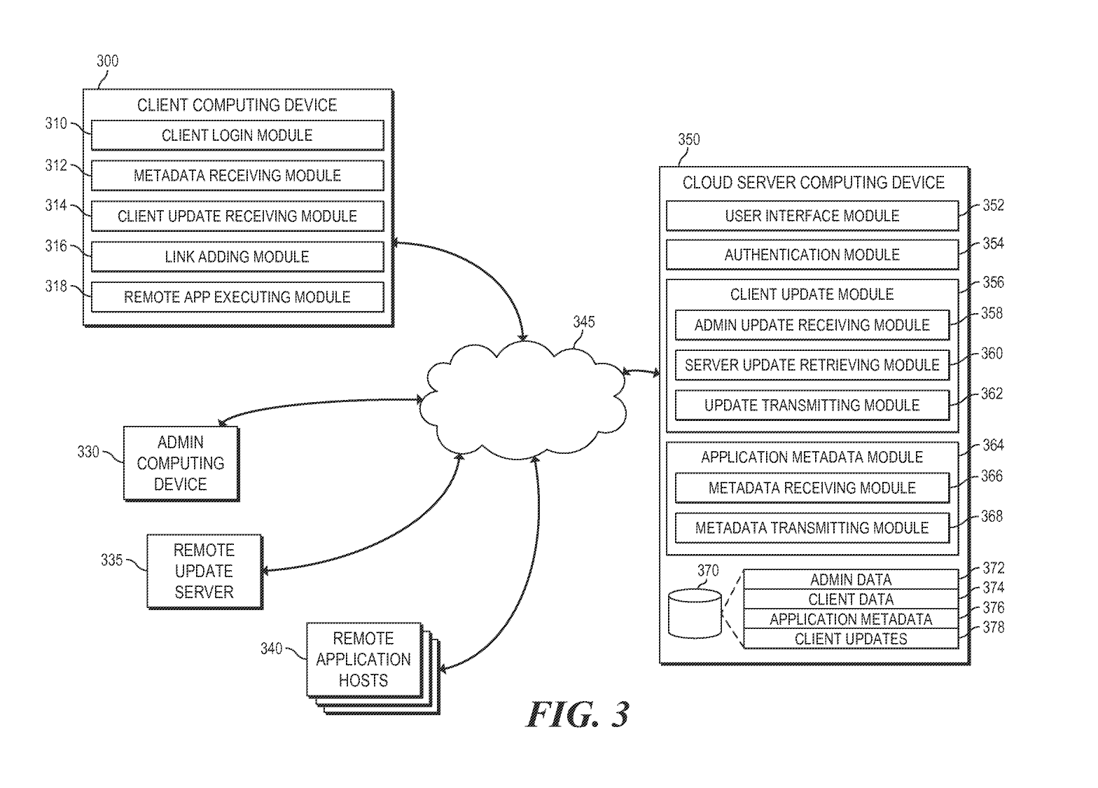

FIG. 3 is a block diagram of an example cloud server computing device 350 in communication via Internet 345 with a client computing device 300, an administrator computing device 330, a remote update server 335, and remote application hosts 340 for enabling remote execution of applications by the client computing device 300. As illustrated in FIG. 3 and described below, server computing device 350 may communicate with client computing device 300 to provide application metadata and client updates, such that client 300 may access remote application hosts 340 to remotely execute applications.

As illustrated, client computing device 300 may include a number of modules 310-318, while cloud server computing device 350 may include a number of modules 352-368. Each of the modules may include a series of instructions encoded on a machine-readable storage medium and executable by a processor of the respective device 300, 350. In addition or as an alternative, each module may include one or more hardware devices including electronic circuitry for implementing the functionality described below.

As with client computing device 200 of FIG. 2, client computing device 300 may be a notebook, desktop, tablet, workstation, mobile device, or any other device suitable for executing the functionality described below. As detailed below, client 300 may include a series of modules 310-318 for enabling a user to execute remotely-hosted applications.

Client login module 310 may initially present a login screen transmitted by server computing device 350. For example, upon initialization of the operating system of client 300, client login module 310 may connect to server 350 at a predetermined URL, receive a login interface from server 350, and display the login interface to the user. In response, the user may enter login credentials into the login interface, such as a user name and password. Client login module 310 may then transmit the entered credentials to server computing device 350. Further details regarding an example implementation of client login module 310 are provided above in connection with login credential providing instructions 222 of FIG. 2.

Metadata receiving module 312 may then receive application metadata describing the applications made available to the particular client by a system administrator. For example, receiving module 312 may receive metadata transmitted by server 350 that includes an identification of one or more applications, such as a name of the application and a description of the application. The metadata may also include information identifying a location of a host device 340 for each application, such as an IP address and a port number. Further details regarding an example implementation of metadata receiving module 312 are provided above in connection with metadata receiving instructions 224 of FIG. 2.

Client update receiving module 314 may then receive one or more client updates from server 350 for each remotely-hosted application. In particular, update receiving module 314 may receive one or more files related to each application that are used to support execution of the application, such as a decoder, VPN client, or driver. Receiving module 314 may then install each client update by, for example, running an install executable or copying the update file(s) to a predetermined location. Further details regarding an example implementation of client update receiving module 314 are provided above in connection with client update installing instructions 226 of FIG. 2.

After receipt of application metadata by metadata receiving module 312, link adding module 316 may then add a link to the remotely-hosted application in a user interface of the operating system of client 300. For example, adding module 316 may add a button, hyperlink, or other user interface element that executes the corresponding remotely-hosted application when selected by the user. The user may thereby launch a remotely-hosted application by simply clicking, touching, or otherwise activating the link for the desired application.

Upon selection of the link for a particular application, remote application executing module 318 may then trigger execution of the corresponding remotely-hosted application. For example, executing module 318 may determine the location of a particular remote host 340, initialize a protocol for connecting to the remote host 340, establish a connection with the host 340, and begin remote execution of the application. Further details regarding an example implementation of remote application executing module 318 are provided above in connection with remote application executing instructions 228 of FIG. 2.

As with client computing device 300, administrator computing device 330 may be a desktop, notebook, workstation, mobile device, or any other computing device for enabling a system administrator to provide application metadata to server computing device 350. Administrator computing device 330 may initially establish a connection with server 350, receive an administrator user interface, and display the user interface to the administrative user.

The administrator may then provide information identifying remotely-hosted applications and available remote application hosts 340. For example, the administrator may specify the name of an application and the location of a remote host 340 of the application. In some implementations, the administrator may also specify application permissions to be used by server 350 in controlling access to remotely-hosted applications. For example, the administrator may specify the user identifiers of users who will be permitted execute each remotely-hosted application. In addition, the administrator may also upload client updates for the remotely-hosted applications. After gathering the application metadata and any permission and client update data, administrator computing device 330 may then transmit the data to server computing device 350.

Remote update server 335 may be any computing device suitable for storage of client updates and transmission of the updates to cloud server computing device 350. For example, remote update server 335 may maintain an inventory of update files for each of a number of remotely-hosted applications. Upon receipt of a request from cloud server 350 identifying a particular application, remote update server 335 may retrieve any related client update files from storage and transmit the updates to cloud server 350.

Remote application hosts 340 may be any computing devices suitable for locally executing an application on behalf of a particular client device, such as client computing device 300. Thus, each application host 340 may include instructions for executing a particular application. Upon receipt of a request from a particular client, the application host 340 may begin executing an instance of the requested application, provide graphics data for the executing application to the client over network 345, and subsequently receive input data from the client over network 345. Application host 340 may then process the input within the application and provide updated graphics data to the client. By repeating this process, application host 340 may enable a user of a client to interact with the application on the client as if the client were locally executing the application.

As with cloud server 100 of FIG. 1, cloud server computing device 350 may be any server accessible to client 300 over the Internet 345 that is suitable for executing the functionality described below. As detailed below, server 350 may include a series of modules 352-368 for enabling client devices to execute remotely-hosted applications.

User interface module 352 may manage the process for providing user interfaces to both administrators and clients. Thus, user interface module 352 may initially provide a user interface to administrator computing device 330. The interface may first request login information from the administrator and, upon receipt of the login information, request that authentication module 354 determine whether the administrator is properly authenticated. If the administrator is properly authenticated, interface module 352 may then present an additional interface that allows the administrator to identify remotely-hosted applications to be available to clients 300 and permission data identifying particular clients that are to be granted permission to each remotely-hosted application. Server 350 may then store the application information in application metadata 376 of storage 370 and the permission data in client data 374 of storage 370.

User interface module 352 may also present a client interface to enable clients to access the application metadata 376. Interface module 352 may initially present a client login interface that requests a client identifier (e.g., a user name) and a corresponding authentication parameter (e.g., a password). Upon receipt of the identifier and authentication parameter, interface module 352 may request that authentication module 354 determine whether the user is properly authenticated. If the user is properly authenticated, client update module 356 and application metadata module 364 may then proceed as detailed below.

Authentication module 354 may manage the process for authenticating administrators and clients based on the login information provided to the respective login interfaces. Upon receipt of an administrator identifier and authentication parameter, authentication module 354 may access administrator data 372 of storage 370 to determine whether the authentication parameter stored for the provided identifier matches the received authentication parameter. If so, authentication module 354 may determine that the administrator is properly authenticated. Similarly, upon receipt of a user identifier and authentication parameter, authentication module 354 may access client data 374 of storage 370 to determine whether the authentication parameter stored for the provided identifier matches the received authentication parameter and, if so, determine that the client is properly authenticated.

Client update module 356 may manage the process for obtaining updates for particular remotely-hosted applications and for transmitting the updates to particular clients. Although the components of client update module 356 are described in detail below, additional details regarding an example implementation of module 356 are provided above in connection with update providing instructions 126 of FIG. 1.

Administrator update receiving module 358 may receive client updates for particular remotely-hosted applications from administrator computing device 330. For example, in some implementations, the administrator interface provided by user interface module 352 may allow the administrator to upload client updates for particular applications to server 350. In response, server 350 may store the updates in client updates 378 of storage 370.

In other implementations, server update retrieving module 360 may download the client updates from a remote update server 335. For example, upon receipt of metadata identifying a remotely-hosted application, update retrieving module 360 may connect to remote update server 335, provide an identification of the remotely-hosted application, and download the client update from update server 335. In response, server 350 may then store the received update in client updates 378 of storage 370.

After obtaining one or more client updates for a remotely-hosted application, update transmitting module 362 may provide the client updates to a particular client device 300. For example, transmitting module 362 may identify the applications included in metadata sent to client 300 by metadata transmitting module 368, retrieve the applicable updates from storage 370, and provide the updates to the client 300. As detailed above, the client 300 may then install the update to prepare for execution of the remotely-hosted application.

Application metadata module 364 may manage the process for obtaining application metadata from an administrator computing device 330 and transmitting the application metadata to a client 300. Although the components of application metadata module 364 are described in detail below, additional details regarding an example implementation of module 364 are provided above in connection with metadata receiving instructions 122 and metadata transmitting instructions 128 of FIG. 1.

Metadata receiving module 366 may initially receive application metadata via the administrator user interface presented by user interface module 352. For example, an administrator may interact with administrator computing device 330 to provide application metadata for each application that is remotely hosted by a given remote application host 340. The metadata may include an identification of each application and a location of a corresponding host device (e.g., an IP address and port number). In response, cloud server 350 may store the metadata 376 in storage device 370.

Metadata transmitting module 368 may then transmit the stored metadata to client computing device 300 upon successful login by a given client. For example, metadata transmitting module 368 may identify the client, determine which applications the particular client is authorized to execute, and provide the stored metadata 376 to the client for the authorized applications. By using the metadata 376 in conjunction with the updates transmitted by update transmitting module 362, client 300 may thereby remotely execute each remotely-hosted application by connecting to the identified remote application host 340.

Storage device 370 may be any hardware storage device for maintaining data accessible to cloud server computing device 350. For example, storage device 370 may include one or more hard disk drives, solid state drives, tape drives, and/or any other storage devices. The storage devices may be located in cloud server 350 and/or in another device in communication with cloud server 350. As detailed above, storage device may maintain administrator data 372, client data 374, application metadata 376, and client updates 378.

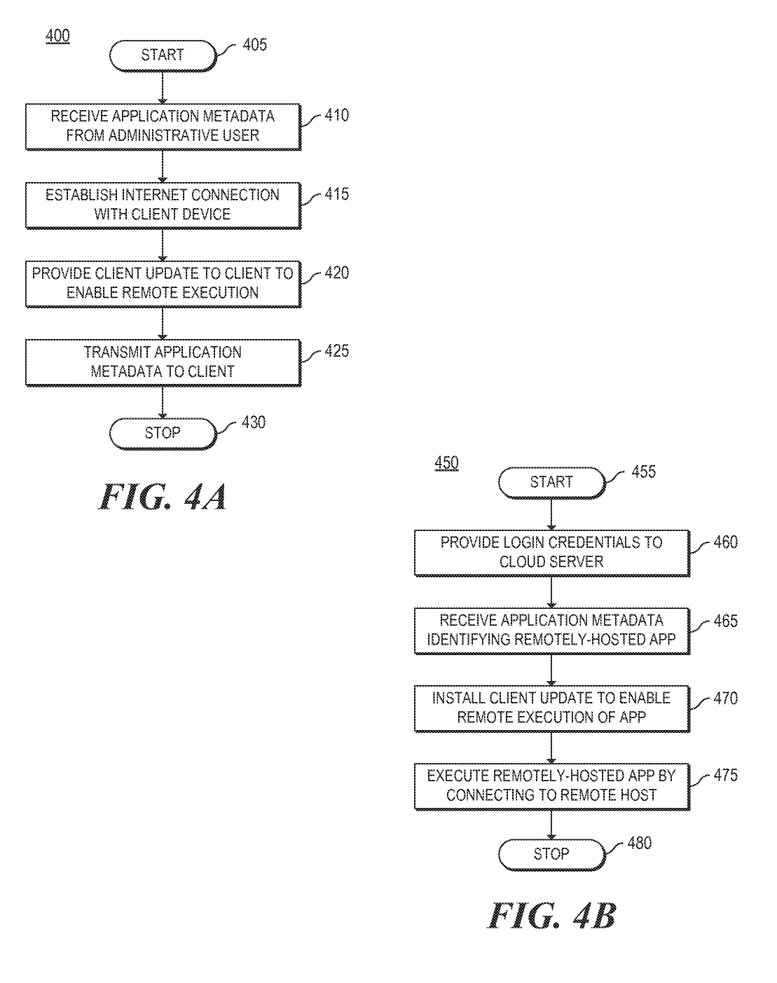

FIG. 4A is a flowchart of an example method 400 for execution by a cloud server computing device 100 for receiving application metadata from an administrative user and forwarding the metadata and a corresponding client update to a client device. Although execution of method 400 is described below with reference to cloud server computing device 100 of FIG. 1, other suitable devices for execution of method 400 will be apparent to those of skill in the art, such as cloud server computing device 350 of FIG. 3. Method 400 may be implemented in the form of executable instructions stored on a machine-readable storage medium, such as storage medium 120, and/or in the form of electronic circuitry.

Method 400 may start in block 405 and continue to block 410, where cloud server 100 may receive application metadata 130 from an administrative user. For example, the administrative user may connect to a web-based application hosted by server 100 and upload metadata 130 identifying available remote host devices and the applications supported by those host devices.

Next, in block 415, cloud server 100 may establish an Internet connection with a particular client device. In block 420, cloud server 100 may then provide the client with any updates used to enable remote execution of the application by the client. As detailed above, each client update 132 may be a set of instructions that provides the client device with the functionality required for or otherwise used to support execution of a remotely-hosted application.

Finally, in block 425, cloud server 100 may transmit the application metadata 134 to the client. Again, the application metadata 134 may include an identification of each remotely-hosted application and a location of the host device that hosts the application. Method 400 may then continue to block 430, where method 400 may stop.

FIG. 4B is a flowchart of an example method 450 for execution by a client computing device 200 for receiving application metadata 234 and a corresponding client update 232 from a cloud server, and utilizing the metadata 234 and update 232 to execute a remotely-hosted application. Although execution of method 450 is described below with reference to client computing device 200 of FIG. 2, other suitable devices for execution of method 400 will be apparent to those of skill in the art, such as client computing device 300 of FIG. 3. Method 450 may be implemented in the form of executable instructions stored on a machine-readable storage medium, such as storage medium 220, and/or in the form of electronic circuitry.

Method 450 may start in block 455 and proceed to block 460, where client computing device 200 may provide login credentials 230 to a cloud server. The login credentials 230 may include, for example, a user name and a password.

Next, in block 465, client 200 may receive application metadata 234 identifying a remotely-hosted application. The metadata 234 may include an identification of the application (e.g., the name, a brief description, etc.) and information suitable for connecting to the remote host (e.g., an IP address and port). In block 470, client 200 may then receive a client update 232 for supporting execution of the remotely-hosted application and install the client update 232. For example, the client update 232 may be a driver, decoder, or any other set of instructions that supports execution of the application.

Finally, after client 200 installs the update 232, method 450 may continue to block 475, where client 200 may execute the remotely-hosted application by connecting to the remote host and utilizing client update 232 to support execution. Method 450 may subsequently proceed to block 480, where method 450 may stop.

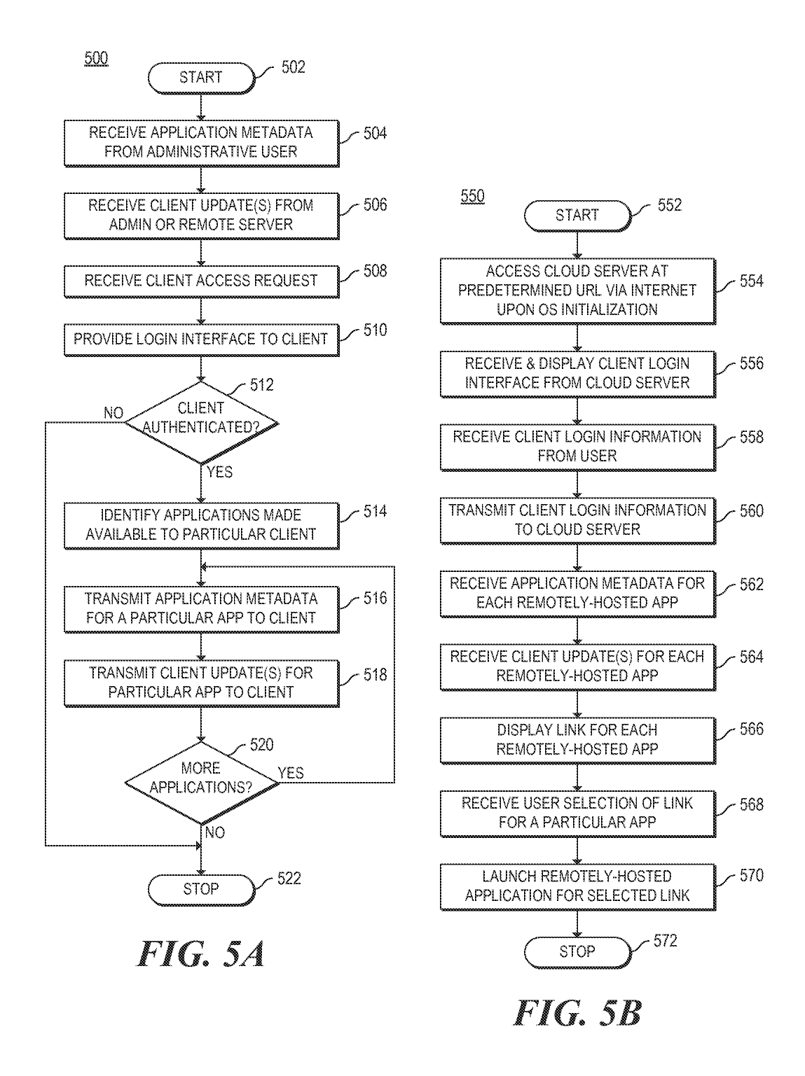

FIG. 5A is a flowchart of an example method 500 for execution by a cloud server computing device 350 for receiving application metadata from an administrative user, authenticating a client device 300, and forwarding the metadata and a corresponding client update to the authenticated client device 300. Although execution of method 500 is described below with reference to cloud server computing device 350 of FIG. 3, other suitable devices for execution of method 500 will be apparent to those of skill in the art. Method 500 may be implemented in the form of executable instructions stored on a machine-readable storage medium and/or in the form of electronic circuitry.

Method 500 may start in block 502 and proceed to block 504, where server 350 may receive application metadata from an administrative user. The application metadata may identify one or more remotely-hosted applications and a corresponding host device 340 for each application. Next, in block 506, server 350 may receive a client update from an administrator computing device 330 or a remote update server 335. The client update may be any file or set of files for supporting execution of a particular remotely-hosted application by a client.

In block 508, server 350 may then receive an access request from a particular client device 300. For example, client 300 may connect to server 350 over Internet 345 during an operating system initialization routine. In response, in block 510, server 350 may then provide a login interface to client 300 requesting a user identifier and an authentication parameter.

In block 512, server 350 may determine whether the client is properly authenticated based on the provided user identifier and authentication parameter. For example, server 350 may access a storage device 370 to determine whether the stored authentication parameter for the provided user identifier matches the entered authentication parameter. If the user is not authenticated, method 500 may proceed to block 522, where method 500 may stop.

Otherwise, when the user is properly authenticated, method 500 may continue to block 514. In block 514, server 350 may then identify the applications made available to the particular client 300 by the administrator. For example, server 350 may access permission information from storage 370 to determine which remotely-hosted applications have been made available to the particular client.

Next, in block 516, server 350 may transmit the application metadata for the first remotely-hosted application to client 300. In block 518, server 350 may then transmit any available client updates for the remotely-hosted application to client 300. After transmitting the application metadata and all available updates, method 500 may then continue to block 520, where server 350 may determine whether there are additional remotely-hosted applications made available to the client. If so, method 500 may return to blocks 516 and 518 for transmission of the metadata and update(s) for the next application and server 350 may continue this process until all metadata and updates have been transmitted to the client. When server 350 has transmitted the metadata and update(s) for all available applications, method 500 may continue to block 522, where method 500 may stop.

FIG. 5B is a flowchart of an example method 550 for execution by a client computing device 300 for providing authentication information to a cloud server 350, receiving application metadata and a corresponding client update from the cloud server 350, and utilizing the metadata and update to execute a remotely-hosted application. Although execution of method 500 is described below with reference to client computing device 300 of FIG. 3, other suitable devices for execution of method 550 will be apparent to those of skill in the art. Method 550 may be implemented in the form of executable instructions stored on a machine-readable storage medium and/or in the form of electronic circuitry.

Method 550 may start in block 552 and proceed to block 554, where client 300 may access a cloud server at a predetermined URL upon or during initialization of the operating system of client 300. For example, client 300 may access cloud server 350 at an Internet-accessible URL after initializing its network interface.

Next, in block 556, client 300 may receive a client login interface from cloud server 350 and display the login interface. After receiving login information from the user in block 558, client 300 may transmit the login information to cloud server 350 in block 560.

Assuming the client is properly authenticated by cloud server 350, client 300 may then begin receiving application metadata from server 350 in block 562 and receiving corresponding client updates from server 350 in block 564. In this manner, client 300 may receive application metadata and any applicable client updates for each remotely-hosted application made available to the user by an administrator.

After receiving application metadata for each remotely-hosted application, method 550 may continue to block 566, where client 300 may output a link for each remotely-hosted application. For example, client 300 may display an icon, hyperlink, or other interface element that launches the remotely-hosted application when selected.

In block 568, client 300 may then receive a user's selection of the displayed link for a particular remotely-hosted application. Next, in block 570, client 300 may launch the selected application by initializing an appropriate protocol and connecting to the specified remote host 340. After the remotely-hosted application is terminated, method 550 may then proceed to block 572, where method 550 may stop.

The foregoing disclosure describes a number of example embodiments for enabling a remote application hosting framework by distributing application metadata and client updates from a cloud-based server. In this manner, the embodiments disclosed herein enable simple administration of a remote application hosting framework, as a client may be automatically configured for remote execution of applications by simply connecting to the server and receiving the appropriate metadata and client updates.

We claim:

1. A cloud server computing device for enabling remote execution of applications, the cloud server computing device comprising:
a processor to:
receive application metadata provided by an administrative user, the application metadata identifying a remotely-hosted application and a location of a corresponding host device that hosts the application,
establish communication with a client device,
provide a client update to the client device, the client update enabling remote execution of the remotely-hosted application by the client device, and
transmit the application metadata to the client device to enable remote execution of the remotely-hosted application by the client device by connecting to the corresponding host device and using the client update.

2. The cloud server computing device of claim 1, wherein the cloud server computing device further comprises:
a storage device for storing the client update for each remotely-hosted application for which an update is available.

3. The cloud server computing device of claim 2, wherein the processor is further to:
receive the client update from the administrative user prior to providing the client update to the client device, and
store the received client update on the storage device.

4. The cloud server computing device of claim 2, wherein the processor is further to:
retrieve the client update from a remote server by providing an identification of the remotely-hosted application to the remote server, and
store the retrieved client update on the storage device.

5. The cloud server computing device of claim 1, wherein the processor is further to:
receive a client identifier and an authentication parameter from the client device, and
select the application metadata and the client update transmitted to the client device based on the received client identifier and permission data specified by the administrative user.

6. The cloud server computing device of claim 1, wherein the client update includes at least one of:
a decoder for use by the client device in decoding a stream of data to be provided by the host device,
a virtual private network (VPN) client for use by the client device in connecting to the host device,
a hardware driver for improving performance of the client device when executing the remotely-hosted application,
a management tool update for enabling the administrative user to remotely connect to the client device, and
a local device redirector for enabling redirection of resources from the client device to the host device.

7. A method for execution by a cloud server computing device for enabling remote execution of applications, the method comprising:
presenting, by the cloud server computing device, an administrative user interface to enable an administrative user to identify a remotely-hosted application for execution by a client device;
receiving application metadata via the administrative user interface, the metadata identifying the remotely-hosted application and a corresponding host device;
receiving a client update to enable remote execution of the remotely-hosted application by the client device;
providing the client update to the client device; and
transmitting the application metadata to the client device to enable remote execution of the remotely-hosted application by the client device by connecting to the corresponding host device and using the client update.

8. The method of claim 7, further comprising:
presenting a client login interface for receiving a client identifier and a corresponding authentication parameter;
receiving the client identifier and the authentication parameter from the client device; and
selecting the client update and the application metadata for transmission to the client device based on the client identifier and permission data specified by the administrative user.

9. The method of claim 7, wherein receiving the client update comprises one of:
receiving the client update from the administrative user via the administrative user interface, and
receiving the client update from a remote server based on provision of an identification of the remotely-hosted application to the remote server.

10. The method of claim 7, wherein the client update includes at least one of:
a decoder for use by the client device in decoding a stream of data to be provided by the host device,
a virtual private network (VPN) client for use by the client device in connecting to the host device,
a hardware driver for improving performance of the client device when executing the remotely-hosted application,
a management tool update for enabling the administrative user to remotely connect to the client device, and
a local device redirector for enabling redirection of resources from the client device to the host device.

11. A machine-readable storage medium encoded with instructions executable by a processor of a client computing device for configuration of remotely-hosted applications, the machine-readable storage medium comprising:
instructions for providing login credentials to a server at a predetermined location in response to display of a login interface;
instructions for receiving application metadata corresponding to the provided login credentials, wherein the metadata identifies a remotely-hosted application and a location of a corresponding host device;
instructions for installing a client update received from the server, the client update enabling remote execution of the remotely-hosted application by the client computing device; and
instructions for executing the remotely-hosted application by connecting to the remote host and using the installed client update.

12. The machine-readable storage medium of claim 11, wherein the predetermined location is a Uniform Resource Locator (URL) preinstalled in an operating system of the client computing device.

13. The machine-readable storage medium of claim 12, wherein the operating system automatically connects to the server at the predetermined URL upon initialization of the operating system.

14. The machine-readable storage medium of claim 11, further comprising:
instructions for adding a link to the remotely-hosted application in a user interface of an operating system of the client computing device, wherein the link triggers the instructions for executing when selected.

15. The machine-readable storage medium of claim 11, wherein the login credentials include a user name of a user of the client computing device and a corresponding password.
